(19) United States
(12) Patent Application Publication
(10) Pub. No.: US 2024/0020903 A1
(43) Pub. Date: Jan. 18, 2024

(54) VIRTUAL SPACE SHARING SYSTEM, VIRTUAL SPACE SHARING METHOD, AND VIRTUAL SPACE SHARING PROGRAM

(71) Applicants: NATIONAL INSTITUTE OF ADVANCED INDUSTRIAL SCIENCE AND TECHNOLOGY, Tokyo (JP); RIKEN, Wako-shi (JP)

(72) Inventors: Akihiko MURAI, Tsukuba-shi Ibaraki (JP); Masaaki MOCHIMARU, Tsukuba-shi Ibaraki (JP); Satoshi OOTA, Wako-shi (JP); Shigeho NODA, Wako-shi (JP)

(21) Appl. No.: 18/361,315

(22) Filed: Jul. 28, 2023

Related U.S. Application Data
(63) Continuation of application No. PCT/JP2022/001629, filed on Jan. 18, 2022.

(30) Foreign Application Priority Data
Jan. 29, 2021 (JP) JP2021-013755

(51) Int. Cl. G06T 13/40; G06T 7/20

(52) U.S. Cl. CPC G06T 13/40; G06T 7/20; G06T 2207/30196

(57) ABSTRACT

A virtual space sharing system 1 for causing a first moving body 10 and a second moving body 12 is disclosed. The virtual space sharing system includes: a virtual space display unit 20, 22; a delay time measurement unit 30 that measures a communication delay time between the first moving body 10 and the second moving body 12; a motion prediction unit 40 and the second moving body 12; and a display control unit 50 that displays, on the virtual space display unit 20, 22, a motion of the first moving body 10 predicted by the motion prediction unit 40 to be occurring at a point of time into the future by the communication delay time and a motion of the second moving body 12 predicted by the motion prediction unit 40 to be occurring at a point of time into the future by the communication delay time.

### TECHNICAL FIELD

The present invention relates to a virtual space sharing system, a virtual space sharing method, and a virtual space sharing program.

### BACKGROUND ART

A system for supporting realtime dance interaction between dancers at remote locations on a virtual reality space of a computer has been proposed (see, for example, non-patent literature 1). This system is configured to connect multiple motion captures via a network to realize dance interaction.
[Non-patent literature 1] “Research on Interaction System of Tele-Dance with Motion Capture and Network”, Information Processing Society of Japan, collection of symposium papers (Information Processing Society of Japan workshop, collection of papers), pp. 173-178, Dec. 16, 2005, https://ipsj.ixsq.nii.ac.jp/ej/?action=repository_uri&item_id=100523&file_id=1&file_no=1

### SUMMARY OF INVENTION

### Technical Problem

It is possible to cause multiple human beings, robots, or avatars at multiple sites to share the same virtual space by connecting multiple human beings, robots, and avatars via a network by using a motion/physiological data measurement system such as a motion capture, robot system, virtual space building system, etc. In this case, however, information degradation such as communication delay occurs due to the quality of network or communicated data volume. This makes it difficult to share a virtual space in real time. For example, the related art like that of non-patent literature 1 cannot guarantee that a captured dancing action is displayed in real time, i.e., that a delay does not occur.

The present invention addresses the above situation, and a purpose thereof is to realize realtime virtual space sharing via a network.

### Solution to Problem

A virtual space sharing system according to an aspect of the present invention is a virtual space sharing system for causing a first moving body and a second moving body connected via a network to share mutual states (e.g., motion information, video, audio, other physiological information, force information, etc.) on a virtual space of a computer, the system including; a virtual space display unit that displays the virtual space of a computer; a delay time measurement unit that measures a communication delay time between the first moving body and the second moving body; a motion prediction unit that predicts a future motion of the first moving body and the second moving body; and a display control unit that displays, on the virtual space display unit, a motion of the first moving body predicted by the motion prediction unit to be occurring at a point of time into the future by the communication delay time and a motion of the second moving body predicted by the motion prediction unit to be occurring at a point of time into the future by the communication delay time.

Each of the first moving body and the second moving body may be a human being, a robot, or an avatar.

The motion prediction unit may include: a motion data acquisition unit that acquires motion data for a motion at multiple sites of the first moving body and the second moving body; a motion reproduction unit that refers to the motion data and reproduces the motion of the moving body and the moving body; a feature amount extraction unit that refers to the motion reproduced and extracts a first feature amount; a first model parameter calculation unit that calculates a first model parameter by applying the first feature amount to a motion representation model; a second model parameter generation unit that generates a second model parameter by changing a value of the first model parameter; a feature amount calculation unit that applies the second model parameter to the motion representation model to calculate a second feature amount; a motion prediction execution unit that predicts a future motion of the first moving body and the second moving body based on the second feature amount.

The motion representation model may include a model that models a skeletal frame of a moving body into a plurality of bones and a plurality of flexible and stretchable muscles, each of the bones may have a single rotatable joint at an end, adjacent bones may be joined by the joint, and the joint may be moved by the muscle.

The motion representation model may be a SLIP model.

The delay time measurement unit may measure the communication delay time when the first moving body and the second moving body start connection via the network.

The delay time measurement unit may measure the communication delay time while the first moving body and the second moving body are connected via the network.

Another aspect of the present invention relates to a virtual space sharing method. The method is a virtual space sharing method for causing a first moving body and a second moving body connected via a network to share mutual states on a virtual space of a computer, the method including; measuring a communication delay time between the first moving body and the second moving body; predicting a future motion of the first moving body and the second moving body; and displaying, on a virtual space display unit for displaying a virtual space of a computer, a motion of the first moving body predicted by the predicting to be occurring at a point of time into the future by the communication delay time and a motion of the second moving body predicted by the predicting to be occurring at a point of time into the future by the communication delay time.

Another aspect of the present invention relates to a virtual space sharing program. A virtual space sharing program for causing a first moving body and a second moving body connected via a network to share mutual states on a virtual space of a computer, the program including computer-implemented modules including; a delay time measurement module that measures a communication delay time between the first moving body and the second moving body; a motion prediction module that predicts a future motion of the first moving body and the second moving body; and a display control module that displays, on a virtual space display unit for displaying a virtual space of a computer, a motion of the first moving body predicted by the motion prediction module to be occurring at a point of time into the future by the communication delay time and a motion of the second moving body predicted by the motion prediction module to be occurring at a point of time into the future by the communication delay time.

Optional combinations of the aforementioned constituting elements, and implementations of the embodiment in the form of methods, apparatuses, systems, recording mediums, and computer programs may also be practiced as additional modes of the present invention.

### Advantageous Effects of Invention

According to the present invention, it is possible to realize realtime virtual space sharing via a network.

### BRIEF DESCRIPTION OF DRAWINGS

FIG. 1 is a functional block diagram of a virtual space sharing system according to the first embodiment;

FIG. 2 is a functional block diagram showing a configuration of the motion prediction unit;

FIG. 3 is a schematic diagram showing a concept of the SLIP model;

FIG. 4 is a schematic diagram showing a concept of neuromusculoskeletal simulation; and

FIG. 5 is a flowchart showing a sequence of steps of the virtual space sharing method according to the second embodiment.

### DESCRIPTION OF EMBODIMENTS

### First Embodiment

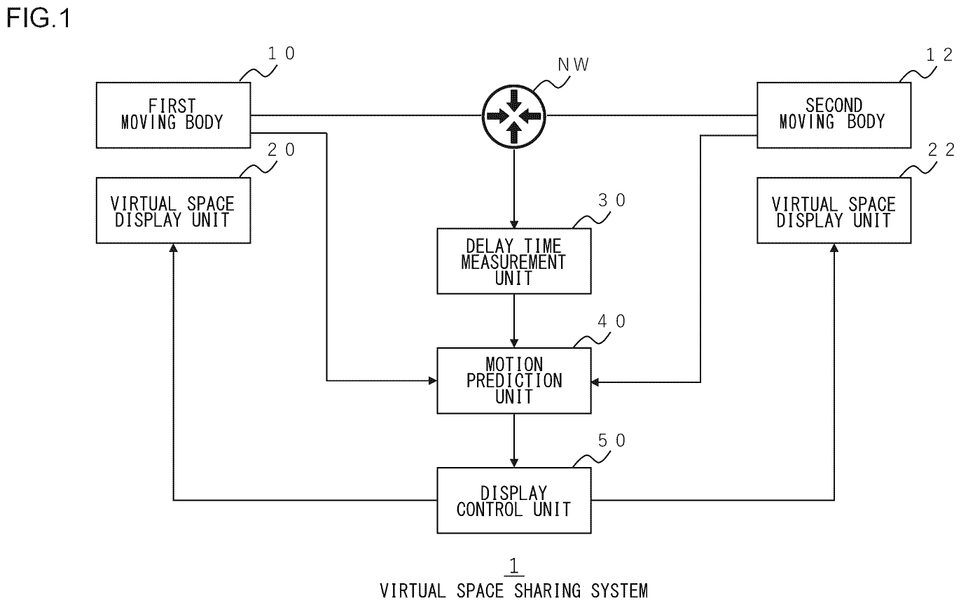

FIG. 1 is a functional block diagram of a virtual space sharing system 1 according to the first embodiment. The virtual space sharing system 1 is a system for causing a first moving body 10 and a second moving body 12 connected via a network NW to share mutual states on a virtual space of a computer. The virtual space sharing system 1 is provided with virtual space display units 20, 22, a delay time measurement unit 30, a motion prediction unit 40, and a display control unit 50.

The first moving body 10 and the second moving body 12 are physical entities capable of moving and are exemplified by a human being, a robot that moves like a human being, an avatar simulating a human being, etc. The first moving body 10 and the second moving body 12 are communicably connected via the network NW. The network NW is an arbitrary wired or wireless communication network.

The virtual space display units 20, 22 are display devices that display the states in which the first moving body 10 and the second moving body 12 move on a virtual space of a computer. The virtual space display units 20, 22 may be any suitable display or display equipment such as liquid crystal displays, video projectors, and head-mounted displays. The virtual space display unit 20 is located near the first moving body 10, the second virtual space display unit 22 is located near the second moving body 12, and both display the same state. This allows the first moving body 10 and the second moving body 12 to share the same virtual space with each other.

The delay time measurement unit 30 measures a communication delay time between the first moving body 10 and the second moving body 12. The delay time is a time required for one-way or reciprocal data communication between the first moving body 10 and the second moving body 12.

The motion prediction unit 40 predicts a future motion of the first moving body 10 and the second moving body 12. Specific steps for prediction of a motion will be described in detail later.

The display control unit 50 displays, on the virtual space display units 20, 22, a motion of the first moving body 10 predicted by the motion prediction unit 40 to be occurring at a point of time into the future by the communication delay time and a motion of the second moving body 12 predicted by the motion prediction unit 40 to be occurring at a point of time into the future by the communication delay time.

According to this embodiment, it is possible to realize realtime virtual space sharing via a network.

In particular, each of the first moving body and the second moving body may be a human being, a robot, or an avatar. When the moving body is a robot or an avatar, the motion prediction unit 40 can predict a future motion of the moving body by applying a motion representation model such as a SLIP model described later. According to this embodiment, it is possible to realize accurate motion prediction by using a motion representation model.

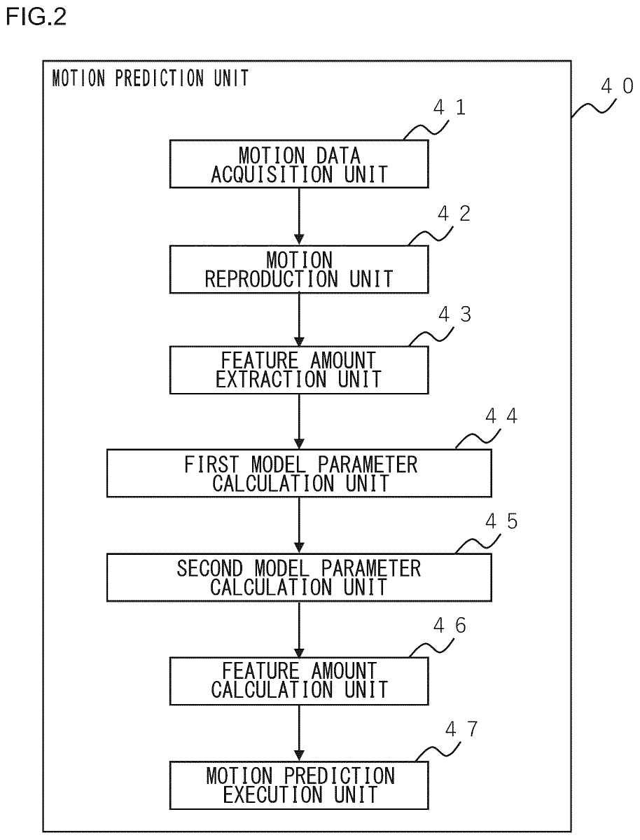

In particular, the motion prediction unit 40 may be provided with a motion data acquisition unit 41, a motion reproduction unit 42, a feature amount extraction unit 43, a first model parameter calculation unit 44, a second model parameter generation unit 45, a feature amount calculation unit 46, and a motion prediction execution unit 47. FIG. 2 is a functional block diagram of the motion prediction unit 40 configured as described above.

The motion data acquisition unit 41 acquires motion data for a motion at multiple sites of the first moving body 10 and the second moving body 12. The motion data acquisition unit 41 is, for example, an optical motion capture. The optical motion capture captures an image of a motion of a subject fitted with a marker at multiple sites of the body. Motion data such as position, speed, and acceleration at the site fitted with a marker can be obtained from the captured image. The motion capture may not be optical but may be mechanical, magnetic, video-based, etc. Another example of the motion data acquisition unit 41 is a force plate. The force plate is used such that a force or a moment applied to the upper surface of the force plate is measured in accordance with a motion state of a subject such as standing, treading, jumping. Alternatively, the motion data may be acquired by using existent means such as a wearable IMU sensor or a pressure sheet (installed or worn), electrocardiograph, electromyograph, electroencephalograph, camera, and microphone (a detailed description is omitted).

The motion reproduction unit 42 refers to the motion data at the sites of the respective markers acquired by the motion data acquisition unit 41 and reproduces the motion of the moving body 10 and the moving body 12 by using a digital human model, etc. The motion reproduction unit 42 reproduces, for example, the body posture, action speed, step length, knee angle, finger motion, joint angle and joint torque of each joint, etc. of the first moving body 10 and the second moving body 12. The reproduction is carried out by “inverse kinematics calculation” based on inverse kinematics and by “inverse dynamics calculation” based on inverse dynamics.

The feature amount extraction unit 43 refers to the motion reproduced by the motion reproduction unit 42 and extracts a first feature amount (singular or multiple) for a motion sought to be predicted. When a future walking motion or running motion is sought to be predicted, for example, the feature amount is locus of mass center, locus of plantar pressure center, leg contact force, etc.

The first model parameter calculation unit 44 calculates the first model parameter by applying the first feature amount extracted by the feature amount extraction unit 43 to the motion representation model. This makes it possible to represent a complicated motion in the form of a simple model. An example of the motion representation model is a SLIP model. A SLIP model is a model of the body of a human being that defines it as being comprised of springs and dampers. The detail of the SLIP model will be described later.

The first model parameter reflects physical features such as physique or build and motion-related features such as physical ability, posture, and habit of the first moving body 10 and the second moving body 12. Therefore, the first model parameter includes just the right amount of information that serves as a basis for predicting a future motion of the first moving body 10 and the second moving body 12. The calculation performed by the first model parameter calculation unit 44 is “mathematical optimization calculation” that calculates a model parameter based on motion-related feature amounts such as locus of mass center, locus of plantar pressure center, and leg contact force.

The second model parameter generation unit 45 generates the second model parameter by changing the value of the first model parameter calculated by the first model parameter calculation unit 44. In this case, the value of an environmental variable (e.g., initial position of mass center, initial speed of mass center, etc.) may be changed in addition to the value of the model parameter, thereby generating an environmental variable having a new value. The second model parameter generation unit 45 transforms the motion of the first moving body 10 and the second moving body 12 from the motion acquired by the motion data acquisition unit 41 to a future motion.

The feature amount calculation unit 46 applies the second model parameter generated by the second model parameter generation unit 45 to the aforementioned motion representation model to calculate the second feature amount. The second feature amount is a feature amount related to a future motion based on the second model parameter. As described with reference to the feature amount extraction unit 43, the calculated feature amount is locus of mass center, locus of plantar pressure center, leg contact force, etc. in the case the motion is walking or running.

Thus, a future motion of the first moving body 10 and the second moving body 12 is generated by changing the model parameter related to the first moving body 10 and the second moving body 12. It is therefore made clear “which model parameter should be changed and in what way it should be changed in order to realize a motion a certain period of time ahead (i.e., a certain period of time into the future)”. Stated otherwise, a motion of the first moving body 10 and the second moving body 12 a certain period of time ahead (i.e., a certain period of time into the future) can be predicted by finding a proper model parameter.

The calculation performed by the motion reproduction unit 42 is inverse kinematics calculation, but the calculation performed by the feature amount calculation unit 46 is “forward dynamics calculation” that calculates the motion-related feature amounts such as locus of mass center, locus of plantar pressure center, leg contact force, etc., based on the model parameter.

The motion prediction execution unit 47 predicts a future motion of the first moving body 10 and the second moving body 12 based on the second feature amount calculated by the feature amount calculation unit 46. For example, the operation of the motion prediction execution unit 47 performed in the case the SLIP model is used as the motion representation model will be described later.

As described above, it is possible, according to this embodiment, to define a specific configuration of the motion prediction unit 40 to realize a virtual space sharing system.

### [Slip Model]

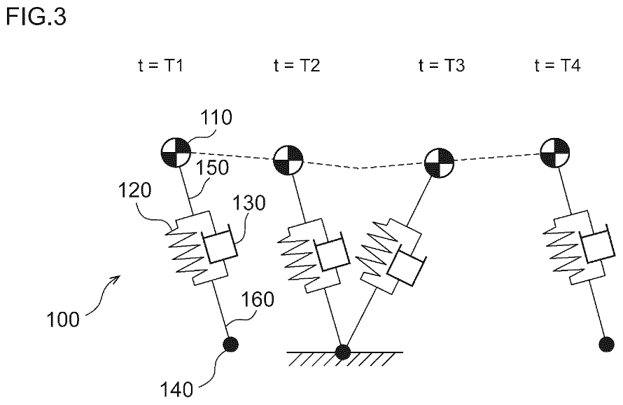

A description will now be given of the SLIP model. FIG. 3 is a schematic diagram showing a concept of the SLIP model. A body model 100 representing the body of a human being is provided with a mass point 110, a spring 120, a damper 130, a contact point 140, a first shaft 150, and a second shaft 160. The mass point 110 is the mass center of the body. The spring 120 and the damper 130 are arranged in parallel. The contact point 140 is located opposite to the mass point 110 across the spring 120 and the damper 130 and can touch an environment such as a floor surface. The first shaft 150 connects the mass point 110, the spring 120, and the damper 130. The second shaft 160 connects the spring 120, the damper 130, and the contact point 140.

Hereinafter, the terms “right” and “left” refer to the orientation defined when the surface of paper is viewed from the front. At time T1, the body model 100 jumps, slightly leaning to the left. In this state, the contact point 140 is removed from the environment. At time T2, the body model 100 lands, still slightly leaning to the left. In other words, the contact point 140 touches the environment at time T2. From time T2 to time T3, the body model 100 leans to the right with the contact point 140 maintaining contact with the environment. At time T3, the body model 100 jumps, still slightly leaning to the right. In other words, the contact point 140 leaves the environment at time T3. From time T3 to time T4, the body model 100 leans to the left with the contact point 140 still being removed from the environment. At time T4, the body model 100 jumps, slightly leaning to the left.

Given such a motion, model parameters such as spring coefficient Kleg, damper coefficient Dleg, and natural leg length Lleg,0 can be calculated by measuring leg contact force Fleg(t) and leg length Lleg(t) experimentally at time T1, T2, T3, and T4. More specifically, Kleg, Dleg, Lleg,0 are calculated by performing optimization for minimizing Ef given by the following expression (1).

E_{f}=Σ^{T}ₜ(F_{leg}(t)−(K_{leg}(L_{leg}(t)−L_{leg,0})+D_{leg}\dot{L}_{leg}(t)))² (1)

By changing the values of the model parameters Kleg, Dleg, Lleg,0, model parameters having new values can be generated. In this case, the value of an environmental variable (e.g., initial position of mass center HCOM(0), initial speed of mass center VCOM(0), etc.) may be changed in addition to the value of the model parameter, thereby generating an environmental variable having a new value. This process here means transforming the motion of a subject from the motion acquired by the motion data acquisition unit to a future motion. More specifically, joint stiffness, etc. can be changed by changing the model parameters Kleg, Dleg, Lleg,0. Further, the height of the floor surface, etc. can be changed by changing the environmental variables HCOM(0), VCOM(0).

In the case the SLIP model is used, the motion prediction execution unit 47 optimizes parameters α and β to minimize Em given by the following expression (2) in the first motion data acquired by the motion data acquisition unit 41 and the first feature amount extracted by the feature amount extraction unit 43. By substituting the feature amount related to the motion calculated by the feature amount calculation unit 46 into the expression (2), the locus of motion of all markers can be re-built as a future locus.

Eₘ=Σ^{T}ₜ(Pₘₐᵣ^{dd}(i,j,t)−M(P_{CoM}^{dd}(t),P_{CoP}^{dd}(t)))² (2)

M(P_{CoM,j}(t),P_{COP,j}(t))=(α(P_{COM,j}(t)−P_{COP,j}(t))+β)² (3)

where Pmar: marker position, PCOM: position of mass center, PCOP: position of plantar pressure center.

In particular, the motion representation model may include a model that models the skeletal frame of a moving body into multiple bones and multiple flexible and stretchable muscles. In this case, each of the bones may have a single rotatable joint at the end, and adjacent bones may be joined by the joint. In this case, the joint may be moved by the muscle. Simulation of a motion using such a model is originally devised by us and is referred to as “neuromusculoskeletal simulation”.

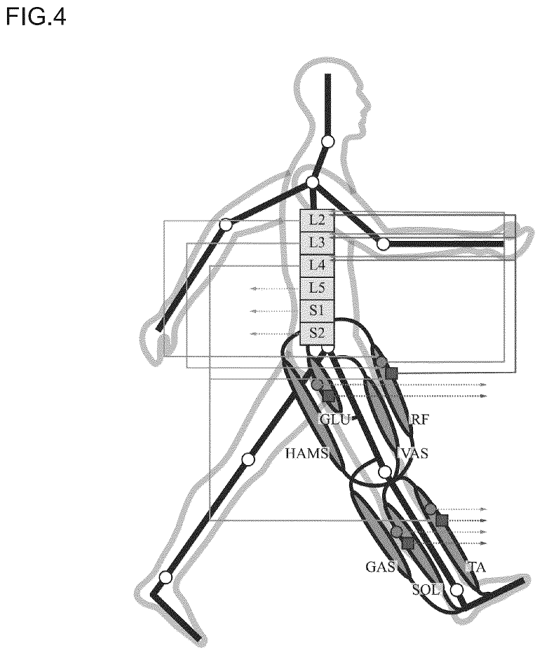

FIG. 4 is a schematic diagram showing a concept of neuromusculoskeletal simulation. FIG. 4 shows the skeleton in the right femoral area and the leg area of a human in a median cross section. In this case, the femoral area and the leg area are modeled by the thighbone and the tibial bone adjacent to each other. The thighbone has the hip joint at one end and the knee joint at the other end. The tibial bone has the knee joint at one end and the ankle joint at the other end. These joints are moved by the hamstring, greatest gluteal muscle, anterior tibial muscle, gastrocnemius muscle, rectus muscle of thigh, lateral vastus muscle, and soleus muscle.

The delay time measurement unit 30 may measure the communication delay time when the first moving body 10 and the second moving body 12 start connection via the network NW. In this case, the one-way or reciprocal communication delay time may be measured when, for example, the connection is started, by transmitting and receiving a packet for measurement of a delay time between the first moving body 10 and the second moving body 12. According to this embodiment, measurement may be made only once when the connection is started so that the communication delay time can be measured easily and promptly.

Neuromusculoskeletal simulation shows that a neuromuscular controller built on the basis of the anatomical structure and motion data of a human being can realize response like that of human being to an unexpected external disturbance during a motion. This demonstrates that two strategies identified by biomechanics are produced from one controller for response of a body running in the presence of an obstacle. The result indicates that it is possible for a properly designed motion controller to provide a prompt response to stumbling without selecting or planning a controller intentionally.

According to this embodiment, it is possible to accurately predict a motion such as reflex (particularly in a living structure).

The delay time measurement unit 30 may measure the communication delay time while the first moving body 10 and the second moving body 12 are connected via the network NW. In this case, the one-way or reciprocal communication delay time may be measured during communication by time-stamping a data packet transmitted and received between the first moving body 10 and the second moving body 12. According to this embodiment, realtime measurement is performed even when the communication delay time changes for some reason during communication so that it is possible to make accurate communication delay time measurement.

### Second Embodiment

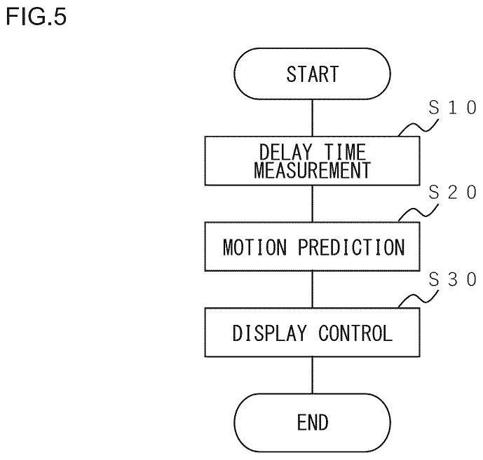

FIG. 5 is a flowchart showing a sequence of steps of the virtual space sharing method according to the second embodiment. The virtual space sharing method is a method for causing the first moving body and the second moving body connected via the network NW to share mutual states on a virtual space of a computer. The method includes a delay time measurement step S10, a motion prediction step S20, and a display control step S30. In the delay time measurement step S10, the method measures a communication delay time between the first moving body and the second moving body. In the motion prediction step S20, the method predicts a future motion of the first moving body and the second moving body. In the display control step S30, the method displays, on a virtual space display unit for displaying a virtual space of a computer, a motion of the first moving body predicted in the motion prediction step S20 to be occurring at a point of time into the future by the communication delay time and a motion of the second moving body predicted in the motion prediction step S20 to be occurring at a point of time into the future by the communication delay time.

According to this embodiment, it is possible to realize realtime virtual space sharing via a network.

### Third Embodiment

The third embodiment relates to a virtual space sharing program. The virtual space sharing program is a program for causing the first moving body and the second moving body connected via the network NW to share mutual states on a virtual space of a computer. The program causes a computer to execute a delay time measurement step S10, a motion prediction step S20, and a display control step S30. In the delay time measurement step S10, a communication delay time between the first moving body and the second moving body is measured. In the motion prediction step S20, a future motion of the first moving body and the second moving body is predicted. In the display control step S30, a motion of the first moving body predicted in the motion prediction step S20 to be occurring at a point of time into the future by the communication delay time and a motion of the second moving body predicted in the motion prediction step S20 to be occurring at a point of time into the future by the communication delay time are displayed on a virtual space display unit for displaying a virtual space of a computer.

According to this embodiment, a program for realizing realtime virtual space sharing via a network can be implemented as computer software.

The present invention has been described above based on the embodiment. The embodiment is intended to be illustrative only and it will be understood by those skilled in the art that various modifications to combinations of constituting elements and processes are possible and that such modifications are also within the scope of the present invention.

### INDUSTRIAL APPLICABILITY

The present invention is applicable to a virtual space sharing system, a virtual space sharing method, and a virtual space sharing program.

### REFERENCE SIGNS LIST

1 . . . virtual space sharing system
10 . . . first moving body
12 . . . second moving body
20 . . . virtual space display unit
22 . . . virtual space display unit
30 . . . delay time measurement unit
40 . . . motion prediction unit
50 . . . display control unit
100 . . . body model
110 . . . mass point
120 . . . spring
130 . . . damper
140 . . . contact point
150 . . . first shaft
160 . . . second shaft
S10 . . . delay time measurement step
S20 . . . motion prediction step
S30 . . . display control step

1. A virtual space sharing system for causing a first moving body and a second moving body connected via a network to share mutual states on a virtual space of a computer, the system comprising;
a virtual space display unit that displays the virtual space of a computer;
a delay time measurement unit that measures a communication delay time between the first moving body and the second moving body;
a motion prediction unit that predicts a future motion of the first moving body and the second moving body; and
a display control unit that displays, on the virtual space display unit, a motion of the first moving body predicted by the motion prediction unit to be occurring at a point of time into the future by the communication delay time and a motion of the second moving body predicted by the motion prediction unit to be occurring at a point of time into the future by the communication delay time.

2. The virtual space sharing system according to claim 1, wherein
each of the first moving body and the second moving body is a human being, a robot, or an avatar.

3. The virtual space sharing system according to claim 1, wherein
the motion prediction unit includes:
a motion data acquisition unit that acquires motion data for a motion at multiple sites of the first moving body and the second moving body;
a motion reproduction unit that refers to the motion data and reproduces the motion of the moving body and the moving body;
a feature amount extraction unit that refers to the motion reproduced and extracts a first feature amount;
a first model parameter calculation unit that calculates a first model parameter by applying the first feature amount to a motion representation model;
a second model parameter generation unit that generates a second model parameter by changing a value of the first model parameter;
a feature amount calculation unit that applies the second model parameter to the motion representation model to calculate a second feature amount;
a motion prediction execution unit that predicts a future motion of the first moving body and the second moving body based on the second feature amount.

4. The virtual space sharing system according to claim 3, wherein
the motion representation model includes a model that models a skeletal frame of a moving body into a plurality of bones and a plurality of flexible and stretchable muscles, each of the bones having a single rotatable joint at an end, adjacent bones being joined by the joint, and the joint being moved by the muscle.

5. The virtual space sharing system according to claim 3, wherein
the motion representation model is a SLIP model.

6. The virtual space sharing system according to claim 1, wherein
the delay time measurement unit measures the communication delay time when the first moving body and the second moving body start connection via the network.

7. The virtual space sharing system according to claim 1, wherein
the delay time measurement unit measures the communication delay time while the first moving body and the second moving body are connected via the network.

8. A virtual space sharing method for causing a first moving body and a second moving body connected via a network to share mutual states on a virtual space of a computer, the method comprising;
measuring a communication delay time between the first moving body and the second moving e body;
predicting a future motion of the first moving body and the second moving body; and
displaying, on a virtual space display unit for displaying a virtual space of a computer, a motion of the first moving body predicted by the predicting to be occurring at a point of time into the future by the communication delay time and a motion of the second moving body predicted by the predicting to be occurring at a point of time into the future by the communication delay time.

9. A virtual space sharing program for causing a first moving body and a second moving body connected via a network to share mutual states on a virtual space of a computer, the program comprising computer-implemented modules including;
a delay time measurement module that measures a communication delay time between the first moving body and the second moving body;
a motion prediction module that predicts a future motion of the first moving body and the second moving body; and
a display control module that displays, on a virtual space display unit for displaying a virtual space of a computer, a motion of the first moving body predicted by the motion prediction module to be occurring at a point of time into the future by the communication delay time and a motion of the second moving body predicted by the motion prediction module to be occurring at a point of time into the future by the communication delay time.
